(19) United States
(12) Patent Application Publication
(10) Pub. No.: US 2026/0340777 A1
(43) Pub. Date: Oct. 29, 2026

(54) METHOD FOR PERFORMING AUTO-TUNING WITH AID OF DEEP LEARNING, AND ASSOCIATED APPARATUS

(71) Applicant: Mediatek Inc., Hsinchu City (TW)

(72) Inventors: Shih-Hung Liu, Hsinchu City (TW); Yu-Chuan Chuang, Hsinchu City (TW); Shuo-En Chang, Hsinchu City (TW); Tsung-Han Chan, Hsinchu City (TW); Ying-Chun Tseng, Hsinchu City (TW); Yi-Hsuan Huang, Hsinchu City (TW); Cheng-Tsai Ho, Hsinchu City (TW)

(73) Assignee: MEDIATEK INC., Hsinchu City (TW)

(21) Appl. No.: 19/186,644

(22) Filed: Apr. 23, 2025

(51) Int. Cl. G06T 5/60; G06T 5/77; G06T 7/00

(52) U.S. Cl. CPC G06T 5/60; G06T 5/77; G06T 7/0002; G06T 2207/20081; G06T 2207/30168

(57) ABSTRACT

A method for performing auto-tuning with aid of deep learning and associated apparatus are provided. The method applicable to a processing circuit may include: receiving an input image with an image signal processing pipeline within the processing circuit to generate a processed image corresponding to the input image and determining an interest region of the processed image, where the interest region of the processed image includes multiple blocks; feeding the multiple blocks into a deep learning network to get individual artifact information for at least one block among the multiple blocks; determining respective weights of multiple predetermined types of artifacts; determining a final image score of the processed image according to the weights and the individual artifact information; and tuning multiple parameters of the image signal processing pipeline according to the final image score.

### BACKGROUND

The present invention is related to image processing, and more particularly, to a method for performing auto-tuning with aid of deep learning, and associated apparatus.

According to the related art, a camera system may be equipped with one or more image signal processors (ISPs) to convert a raw image from an image sensor into a processed image. For example, a camera pipeline in the camera system may comprise multiple modules for different image processing algorithms, and most of these modules may have tunable parameters such as that related to demosaic/de-mosaic, noise reduction (or denoise/de-noise), edge enhancement, etc. In order to achieve the best image quality, the tunable parameters should be adjusted according to the ability of the image processing modules. During a preliminary phase (e.g., a design phase) prior to a mass production phase of the camera system, the manufacturer of the camera system may have a demanding schedule with little free time since huge manual tuning processing with respect to a new image sensor may be required. It seems that no complete solution for automatically tuning the parameters to make the camera pipeline be excellent, in particularly, be capable of converting raw images from the new image sensor into processed images while properly dealing with various kinds of artifacts, can be found in the related art. Thus, a novel method and associated architecture are needed for solving the problems without introducing any side effect or in a way that is less likely to introduce a side effect.

### SUMMARY

It is an objective of the present invention to provide a method for performing auto-tuning with aid of deep learning, and associated apparatus such as a processing circuit (e.g., an image processing circuit) within an electronic device, in order to solve the above-mentioned problems.

At least one embodiment of the present invention provides a method for performing auto-tuning with aid of deep learning. The method can be applied to a processing circuit within an electronic device. For example, the method may comprise: receiving an input image with an image signal processing pipeline to generate a processed image corresponding to the input image and determining an interest region of the processed image, wherein the interest region of the processed image comprises multiple blocks; feeding the multiple blocks into a deep learning network to get individual artifact information for at least one block among the multiple blocks; determining respective weights of multiple predetermined types of artifacts; determining a final image score of the processed image according to the weights and the individual artifact information; and tuning multiple parameters of the image signal processing pipeline according to the final image score.

At least one embodiment of the present invention provides an apparatus that operates according to the above method, where the apparatus may comprise at least the processing circuit within the electronic device. For example, the processing circuit may comprise the deep learning network that is coupled to the image signal processing pipeline, and is arranged to receive the multiple blocks to generate the individual artifact information. More particularly, the deep learning network may represent a first deep learning network of at least one deep learning model, and the processing circuit may further comprise a second deep learning network of another deep learning model, where the second deep learning network is coupled to the image signal processing pipeline. In addition, based on the individual artifact information, the second deep learning network may be arranged to determine the respective weights of the multiple predetermined types of artifacts. According to some embodiments, the apparatus may comprise the whole of the electronic device.

It is an advantage of the present invention that, the method of the present invention, as well as the associated apparatus such as the processing circuit and the electronic device, can perform automatic tuning on the parameters to make the image signal processing pipeline be excellent, and more particularly, be capable of converting all kinds of input images into corresponding processed images while properly dealing with various kinds of artifacts. In addition, the method of the present invention and the associated apparatus such as the processing circuit and the electronic device can significantly reduce the time to market. During a preliminary phase (e.g., a design phase) prior to a mass production phase of the electronic device, the vendor of the processing circuit and/or the manufacturer of the electronic device can optimize the parameters with ease, having no need to hurry everything in a demanding schedule such as that of the camera system in the related art. Additionally, the method of the present invention and the associated apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a whole-image-based control scheme according to an embodiment of the present invention.

FIG. 2 illustrates a partial-image-based control scheme of a method for performing auto-tuning with aid of deep learning according to an embodiment of the present invention.

FIG. 3 illustrates some implementation details of the partial-image-based control scheme shown in FIG. 2 regarding a first deep learning network according to an embodiment of the present invention.

FIG. 4 illustrates some implementation details of the partial-image-based control scheme shown in FIG. 2 regarding a second deep learning network according to an embodiment of the present invention.

FIG. 5 is a flowchart of the method according to an embodiment of the present invention.

FIG. 6 is a diagram illustrating an electronic device involved with the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

Embodiments of the present invention provide a method for performing auto-tuning with aid of deep learning to enhance the performance of an image signal processing pipeline, where the image signal processing pipeline operating according to the parameters that have been processed with the auto-tuning based on the method is capable of converting all kinds of input images into corresponding processed images while properly dealing with various kinds of artifacts. For example, an electronic device may be designed to adopt a processing circuit equipped with the image signal processing pipeline for using the image signal processing pipeline as a camera pipeline, and in a project of the manufacturer of the electronic device, the manufacturer of the electronic device may require the image quality of the processed images from the camera pipeline to align with at least one target image (or the image quality thereof). The aforementioned at least one target image such as one or more target images may be obtained from a predetermined multifunctional mobile device (e.g., an iPhone), a previous project of the manufacturer of the electronic device, at least one camera with the top camera quality on the market, etc., and any target image among the aforementioned at least one target image may have been processed by another camera pipeline (or a different ISP). For better comprehension, the image quality (or at least one factor thereof) may include at least one of noise, texture, artifact, tone, contrast, dynamic range, color, brightness, etc., the artifact may include overshoot/undershoot, contour, edge noise, pattern noise, chroma noise, impulse noise, worm noise, low frequency noise, over/under exposure, purple edge, jaggy edge, false color, ghost, color loss, color bleeding, etc., and the temporal quality may include temporal smooth, temporal noise, flicker, ghost, etc., but the present invention is not limited thereto. In addition, the associated tuning processing may comprise modifying some parameters until the requirement of the image quality is satisfied. The apparatus operating according to the method, such as the processing circuit within the electronic device and/or the entire electronic device (i.e., the whole of the electronic device), can perform the auto-tuning process until the image quality of the processed images aligns with the aforementioned any target image (or the image quality thereof), and more particularly, use at least one deep learning network to get the image quality score of each type of artifacts, employ the deep learning method involved with a second deep learning network to learn the individual weights of different types of artifacts, and sum the products of the learned weights and their corresponding scores to obtain the final image score. Based on the final image score, the auto-tuning process may continually adjust the selected parameters until the image quality of the processed image aligns with the target image standard (or the image quality of the target image). Therefore, the apparatus operating according to the method can predict the image quality which can serve as the baseline for the auto-tuning process, and perform the auto-tuning process accordingly, to enhance the performance of the image signal processing pipeline as well as the overall performance of the electronic device.

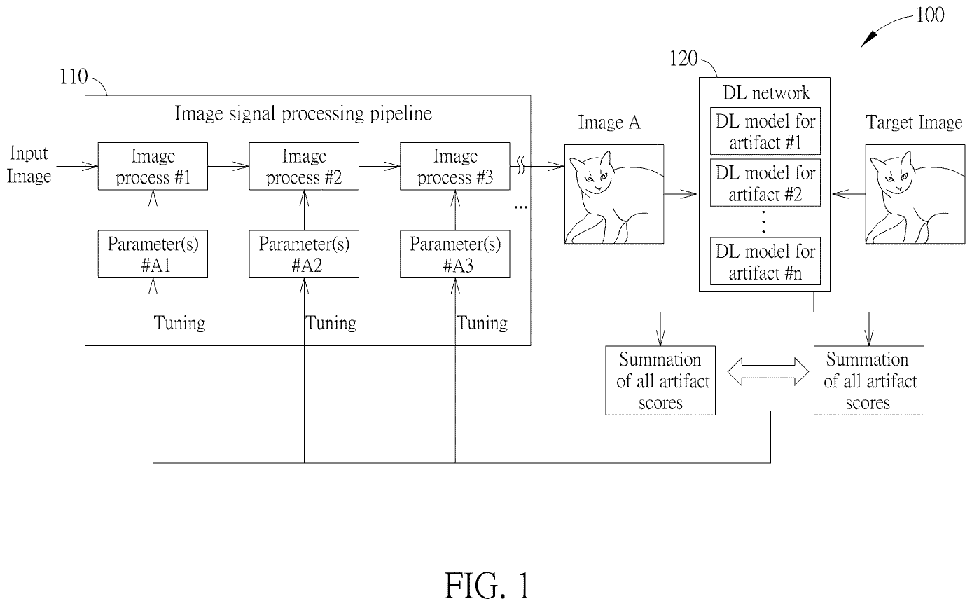

FIG. 1 illustrates a whole-image-based control scheme according to an embodiment of the present invention. Assume that one or more functions of a processing circuit 100 within the electronic device may be temporarily disabled to allow the processing circuit 100 to operate according to the whole-frame-based control scheme shown in FIG. 1, and that “n” may represent a positive integer such as an integer greater than one, but the present invention is not limited thereto. Based on the whole-frame-based control scheme, the processing circuit 100 may select some tunable parameters and subsequently feed the image into a deep learning model, such as any model among the deep learning (DL) models for multiple predetermined types of artifacts #1, #2 . . . and #n (which may be respectively referred to as the artifact #1, the artifact #2 . . . and the artifact #n for brevity), in order to acquire individual artifact scores, respectively, where the summation of these artifact scores directly yields the final image score. For example, both of the image A and the target image may be fed into the same deep learning model, and the respective final image scores of the image A and the target image may be obtained. The processing circuit 100 may compare the final image score of the image A with the final image score of the target image to determine whether the image A is a good processing result of the input image, and more particularly, perform auto-tuning on the selected parameters by the final image score of the image A to get the better result. As many types of artifacts may have more local features than global features, the processing circuit 100 operating according to the whole-image-based control scheme may be unable to properly tune the parameters. According to the subsequent embodiments, the processing circuit 100 may operate according to at least one control scheme of the method to properly tune the parameters, in order to enhance the overall performance.

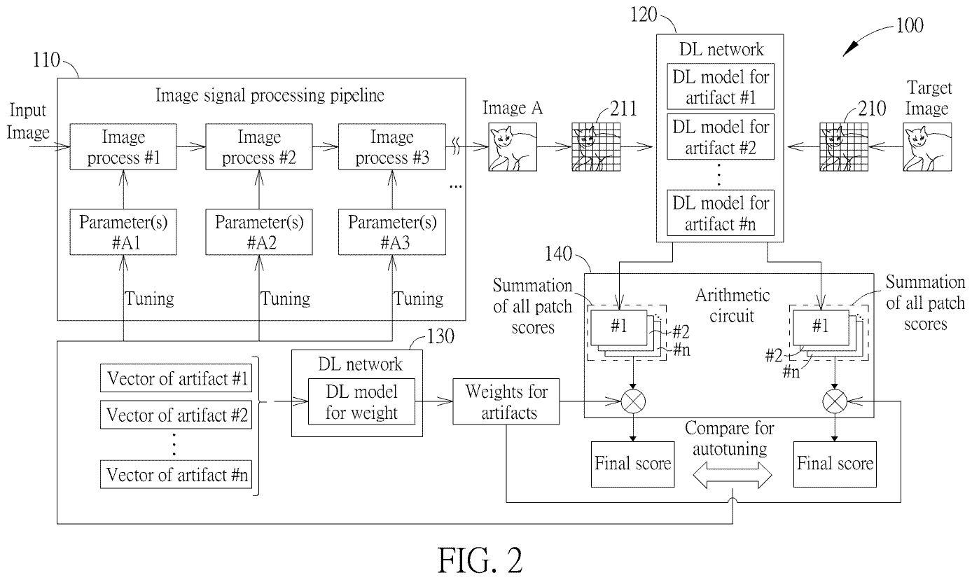

FIG. 2 illustrates a partial-image-based control scheme of the method for performing auto-tuning with aid of deep learning according to an embodiment of the present invention. As shown in FIG. 2, the processing circuit 100 may operate according to the partial-image-based control scheme to achieve a better overall performance. For example, the image signal processing pipeline 110 may comprise a series of image process/processing modules such as the image process/processing modules #1, #2 and #3 (respectively labeled “Image process #1”, “Image process #2” and “Image process #3” for brevity), and under control of the respective parameters #A1, #A2, #A3, etc. of the series of image process/processing modules #1, #2, #3, etc., the image signal processing pipeline 110 may perform image signal processing on the input image to generate a processed image to be the image A, but the present invention is not limited thereto. According to some embodiments, the architecture of the image signal processing pipeline 110 and/or the image process/processing module count of the series of image process/processing modules #1, #2, #3, etc. may vary.

In addition, at least one deep learning model such as the deep learning (DL) models for the multiple predetermined types of artifacts #1, #2 . . . and #n (or the artifact #1, the artifact #2 . . . and the artifact #n) may be implemented for predicting individual image artifact scores, in conjunction with another deep learning model for learning the respective weights {W₁, W₂, . . . , Wₙ} of the multiple predetermined types of artifacts #1, #2 . . . and #n (labeled “DL model for weight” for brevity), where the aforementioned at least one deep learning model may be implemented by way of the aforementioned at least one deep learning network such as the DL network 120, and the other deep learning model may be implemented by way of the second deep learning network such as the DL network 130. More particularly, assuming that “I” and “J” may represent positive integers such as integers greater than one, and that the index i may be an integer in the interval [1, I] and the index j may be an integer in the interval [1, J], the processing circuit 100 may divide the image A into (I*J) first blocks/patches {IMG1_BLK(i, j)|i=1 . . . I, j=1 . . . J} (which may be collectively referred to as the first blocks set 211 or the first patches set 211) for being input into the DL network 120, respectively, and divide the target image into (I*J) target blocks/patches {IMG0_BLK(i, j)|i=1 . . . I, j=1 . . . J} (which may be collectively referred to as the target blocks set 210 or the target patches set 210) for being input into the DL network 120, respectively. For better comprehension, any two first blocks/patches {IMG1_BLK(i, j)} among the (I*J) first blocks/patches {IMG1_BLK(i, j)|i=1 . . . I, j=1 . . . J} may have the same size, any two target blocks/patches {IMG0_BLK(i, j)} among the (I*J) target blocks/patches {IMG0_BLK(i, j)|i=1 . . . I, j=1 . . . J} may have the same size, and any first block/patch IMG1_BLK(i, j) among the (I*J) first blocks/patches {IMG1_BLK(i, j)|i=1 . . . I, j=1 . . . J} and any target block/patch IMG0_BLK(i, j) among the (I*J) target blocks/patches {IMG0_BLK(i, j)|i=1 . . . I, j=1 . . . J} may have the same size, but the present invention is not limited thereto.

For example, the DL network 120 may generate and output the block/patch scores {{IMG1_BLK_SCORE₁(i, j)|i=1 . . . I, j=1 . . . J}, {IMG1_BLK_SCORE₂(i, j)|i=1 . . . I, j=1 . . . J}, . . . , {IMG1_BLK_SCOREₙ(i, j)|i=1 . . . I, j=1 . . . J}} of the first blocks/patches {IMG1_BLK(i, j)|i=1 . . . I, j=1 . . . J} within the first blocks/patches set 211 regarding the multiple predetermined types of artifacts #1, #2 . . . and #n, respectively, and the arithmetic circuit 140 may calculate the summations {Σ_{i=1 . . . , j=1 . . . J} (IMG1_BLK_SCORE₁(i, j)), Σ_{i=1 . . . I, j=1 . . . J} (IMG1_BLK_SCORE₂(i, j)), . . . , Σ_{i=1 . . . I, j=1 . . . J} (IMG1_BLK_SCOREₙ(i, j))} of all block/patch scores {{IMG1_BLK_SCORE₁(i, j)|i=1 . . . I, j=1 . . . J}, {IMG1_BLK_SCORE₂(i, j)|i=1 . . . I, j=1 . . . J}, . . . , {IMG1_BLK_SCOREₙ(i, j)|i=1 . . . I, j=1 . . . J}} of the first blocks/patches {IMG1_BLK(i, j)|i=1 . . . I, j=1 . . . J} within the first blocks/patches set 211 regarding the multiple predetermined types of artifacts #1, #2 . . . and #n, respectively, and sum the products of the learned weights {W₁, W₂, . . . , Wₙ} and their corresponding scores such as the summations {Σ_{i-1 . . . I, j=1 . . . J} (IMG1_BLK_SCORE₁(i, j)), Σ_{i=1 . . . I, j=1 . . . J} (IMG1_BLK_SCORE₂(i, j)), . . . , Σ_{i=1 . . . I, j=1 . . . J} (IMG1_BLK_SCOREₙ(i, j))} to get the final image score IMG1_FINAL_SCORE of the image A as follows:

IMG1_FINAL_SCORE=Σ_{k=1 . . . n}(Wₖ*(Σ_{i=1 . . . I, j=1 . . . J}(IMG1_BLK_SCOREₖ(i, j))));

where the index k may be an integer in the interval [1, n].

In another example, the DL network 120 may generate and output the block/patch scores {{IMG0_BLK_SCORE₁(i, j)|i=1 . . . I, j=1 . . . J}, {IMG0_BLK_SCORE₂(i, j)|i=1 . . . I, j=1 . . . J}, . . . , {IMG0_BLK_SCOREₙ(i, j)|i=1 . . . I, j=1 . . . J}} of the target blocks/patches {IMG0_BLK(i, j)|i=1 . . . I, j=1 . . . J} within the target blocks/patches set 210 regarding the multiple predetermined types of artifacts #1, #2 . . . and #n, respectively, and the arithmetic circuit 140 may calculate the summations {Σ_{i=1 . . . I, j=1 . . . J} (IMG0_BLK_SCORE₁(i, j)), Σ_{i=1 . . . I, j=1 . . . J} (IMG0_BLK_SCORE₂(i, j)), . . . , Σ_{i=1 . . . I, j=1 . . . J} (IMG0_BLK_SCOREₙ(i, j))} of all block/patch scores {{IMG0_BLK_SCORE₁(i, j)|i=1 . . . I, j=1 . . . J}, {IMG0_BLK_SCORE₂(i, j)|i=1 . . . I, j=1 . . . J}, . . . , {IMG0_BLK_SCOREₙ(i, j)|i=1 . . . I, j=1 . . . J}} of the target blocks/patches {IMG0_BLK(i, j)|i=1 . . . I, j=1 . . . J} within the target blocks/patches set 210 regarding the multiple predetermined types of artifacts #1, #2 . . . and #n, respectively, and sum the products of the learned weights {W₁, W₂, . . . , Wₙ} and their corresponding scores such as the summations {Σ_{i=1 . . . I, j=1 . . . J} (IMG0_BLK_SCORE₁(i, j)), Σ_{i=1 . . . I, j=1 . . . J} (IMG0_BLK_SCORE₂(i, j)), . . . , Σ_{i=1 . . . I, j=1 . . . J} (IMG0_BLK_SCOREₙ(i, j))} to get the final image score IMG0_FINAL_SCORE of the target image as follows:

IMG0_FINAL_SCORE=Σ_{k=1 . . . n}(Wₖ*(Σ_{i=1 . . . I, j=1 . . . J}(IMG0_BLK_SCOREₖ(i, j))));

where the index k may be an integer in the interval [1, n].

Based on the partial-image-based control scheme, the processing circuit 100 may compare the final image score IMG1_FINAL_SCORE of the image A with the final image score IMG0_FINAL_SCORE of the target image to determine whether the image A is a good processing result of the input image, and more particularly, perform auto-tuning on the selected parameters such as all of the parameters #A1, #A2, #A3, etc. by the final image score IMG1_FINAL_SCORE of the image A to get the better result. Given that many types of artifacts may have more local features than global features, as the inputs of the DL network 120 have been changed from the target image and the image A to the target blocks/patches set 210 (or the target blocks/patches {IMG0_BLK(i, j)|i=1 . . . I, j=1 . . . J} obtained from dividing the target image) and the first blocks/patches set 211 (or the first blocks/patches {IMG1_BLK(i, j)|i=1 . . . I, j=1 . . . J} obtained from dividing the image A), respectively, the processing circuit 100 operating according to the partial-image-based control scheme can properly tune the parameters #A1, #A2, #A3, etc. of the series of image process/processing modules #1, #2, #3, etc. within the image signal processing pipeline 110 according to the learned weights {W₁, W₂, . . . , Wₙ}, in order to enhance the overall performance. For example, the DL network 130 may perform deep learning with respect to multiple vectors (e.g., multiple predetermined vectors) of the multiple predetermined types of artifacts #1, #2 . . . and #n (or the artifacts #1, #2 . . . and #n) to generate the learned weights {W₁, W₂, . . . , Wₙ} (labeled “Weights for artifacts” for brevity).

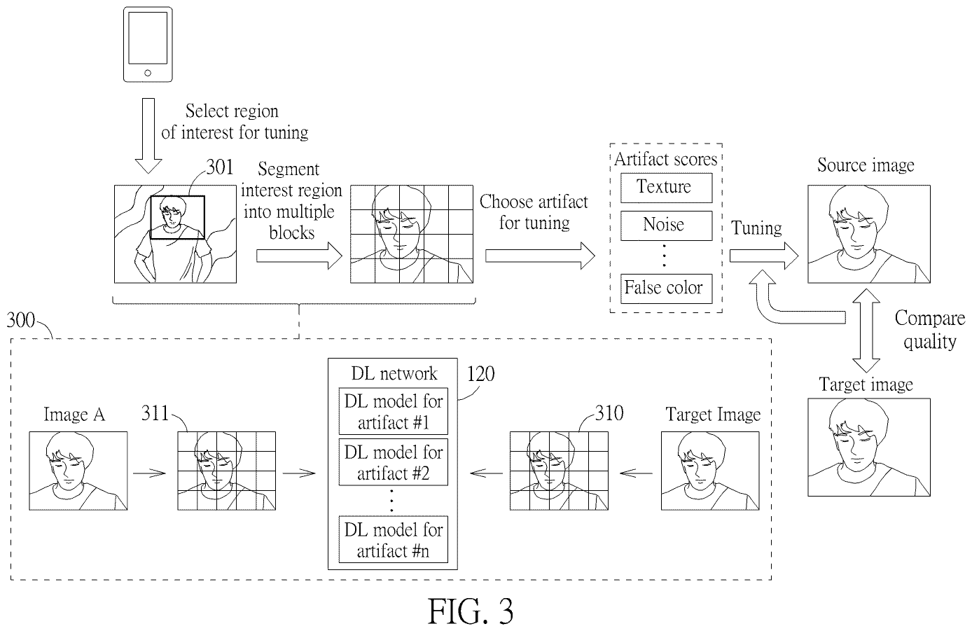

FIG. 3 illustrates some implementation details of the partial-image-based control scheme shown in FIG. 2 regarding a first deep learning network according to an embodiment of the present invention. The image A mentioned above may also be referred to as the source image in this embodiment. For example, a human image may be illustrated as any image among the image A (or the source image) and the target image, and the human image may be arranged to replace the cat image of the embodiment shown in FIG. 2, but the present invention is not limited thereto. In addition, in response to the changes in the image A and the target image, the respective image contents of the first blocks/patches {IMG1_BLK(i, j)|i=1 . . . I, j=1 . . . J} and the target blocks/patches {IMG0_BLK(i, j)|i=1 . . . I, j=1 . . . J} may change correspondingly, and therefore the first blocks/patches set 211 and the target blocks/patches set 210 mentioned above may be rewritten as the first blocks/patches set 311 and the target blocks/patches set 310 in FIG. 3, respectively, where the blocks/patches count (I*J) of any blocks/patches set among the first blocks/patches set 311 and the target blocks/patches set 310 may be different from the blocks/patches count (I*J) of any blocks/patches set among the first blocks/patches set 211 and the target blocks/patches set 210.

As shown in the upper left part of FIG. 3, the processing circuit 100 may provide at least one user interface to allow the user of the electronic device to select, via the aforementioned at least one user interface, a region of interest 301 (or “the interest region 301”) of an original image (e.g., the original image comprising a subset which is equal to the aforementioned any image) to be the aforementioned any image for tuning. After determining the interest region 301 according to the selection of the user, the processing circuit 100 may perform the image division and blocks/patches-to-score conversion operations 300 on the aforementioned any image (e.g., the image A or the target image) to generate one or more sets of block/patch scores {{IMG_BLK_SCOREₖ₀(i, j)|i=1 . . . I, j=1 . . . J}, {IMG_BLK_SCOREₖ₁(i, j)|i=1 . . . I, j=1 . . . J}, . . . } among the associated block/patch scores {{IMG_BLK_SCORE₁(i, j)|i=1 . . . I, j=1 . . . J}, {IMG_BLK_SCORE₂(i, j)|i=1 . . . I, j=1 . . . J}, . . . , {IMG_BLK_SCOREₙ(i, j)|i=1 . . . I, j=1 . . . J}} (e.g., the block/patch scores {{IMG1_BLK_SCORE₁(i, j)|i=1 . . . I, j=1 . . . J}, {IMG1_BLK_SCORE₂(i, j)|i=1 . . . I, j=1 . . . J}, . . . , {IMG1_BLK_SCOREₙ(i, j)|i=1 . . . I, j=1 . . . J}} or the block/patch scores {{IMG0_BLK_SCORE₁(i, j)|i=1 . . . I, j=1 . . . J}, {IMG0_BLK_SCORE₂(i, j)|i=1 . . . I, j=1 . . . J}, . . . , {IMG0_BLK_SCOREₙ(i, j)|i=1 . . . I, j=1 . . . J}}) regarding the multiple predetermined types of artifacts #1, #2 . . . and #n to be the associated artifact scores {{IMG_BLK_SCOREₖ₀(i, j)|i=1 . . . I, j=1 . . . J}, {IMG_BLK_SCOREₖ₁(i, j)|i=1 . . . I, j=1 . . . J}, . . . } of one or more preliminarily chosen artifacts #k0, #k1, etc.

For example, the processing circuit 100 may provide another user interface to allow the user of the electronic device to choose in advance, via the other user interface, one or more types of artifacts #k0, #k1, etc. for tuning, such as the artifacts of texture, noise and false color, to be the one or more preliminarily chosen artifacts #k0, #k1, etc. As the final image score IMG1_FINAL_SCORE of the source image (or the image A) and the final image score IMG0_FINAL_SCORE of the target image may indicate the image quality of the source image and the image quality of the target image, respectively, the processing circuit 100 may compare the respective quality of the source image and the target image by comparing the final image score IMG1_FINAL_SCORE with the final image score IMG0_FINAL_SCORE, for performing the auto-tuning on the selected parameters such as a portion or all of the parameters #A1, #A2, #A3, etc. by the final image score IMG1_FINAL_SCORE of the source image to get the better result. For brevity, similar descriptions for this embodiment are not repeated in detail here.

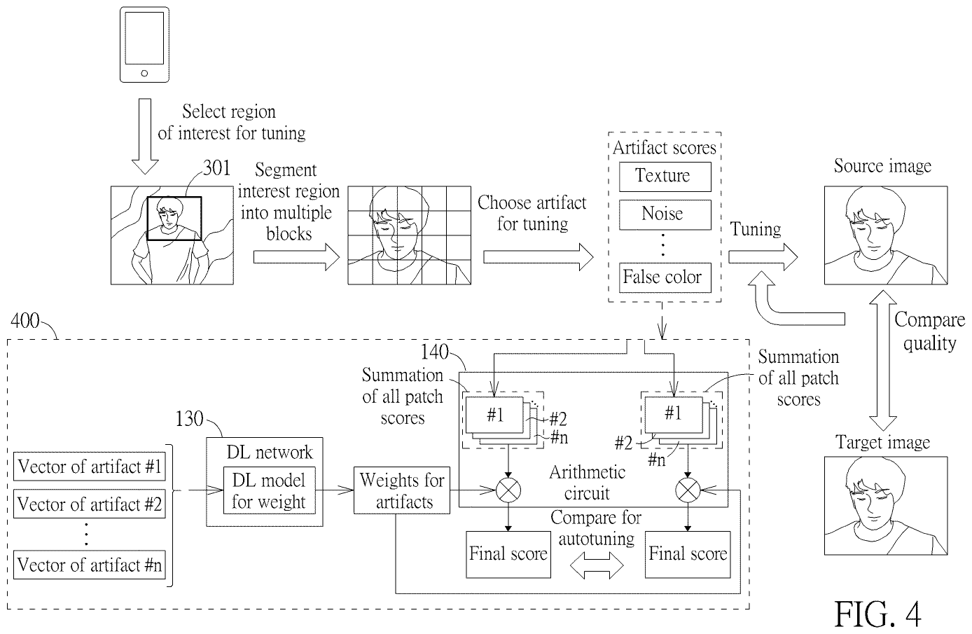

FIG. 4 illustrates some implementation details of the partial-image-based control scheme shown in FIG. 2 regarding the second deep learning network (e.g., the DL network 130) according to an embodiment of the present invention. For example, the processing circuit 100 may provide the other user interface to allow the user of the electronic device to choose the one or more types of artifacts #k0, #k1, etc. for tuning, such as the artifacts of texture, noise and false color, to be the one or more preliminarily chosen artifacts #k0, #k1, etc. In addition, the processing circuit 100 may generate the one or more sets of block/patch scores {{IMG_BLK_SCOREₖ₀(i, j)|i=1 . . . I, j=1 . . . J}, {IMG_BLK_SCOREₖ₁(i, j)|i=1 . . . I, j=1 . . . J}, . . . } as the associated artifact scores {{IMG_BLK_SCOREₖ₀(i, j)|i=1 . . . I, j=1 . . . J}, {IMG_BLK_SCOREₖ₁(i, j)|i=1 . . . I, j=1 . . . J}, . . . } of the one or more preliminarily chosen artifacts #k0, #k1, etc., respectively, and further perform the final score calculation operations 400 according to the associated artifact scores {{IMG_BLK_SCOREₖ₀(i, j)|i=1 . . . I, j=1 . . . J}, {IMG_BLK_SCOREₖ₁(i, j)|i=1 . . . I, j=1 . . . J}, . . . } and the associated weights {Wₖ₀, Wₖ₁, . . . } of the one or more preliminarily chosen artifacts #k0, #k1, etc., for performing the auto-tuning while using at least one portion of weights {Wₖ} among the respective weights {W₁, W₂, . . . , Wₙ} of the multiple predetermined types of artifacts #1, #2 . . . and #n, where the aforementioned at least one portion of weights {Wₖ} may comprise the associated weights {Wₖ₀, Wₖ₁, . . . } of the one or more preliminarily chosen artifacts #k0, #k1, etc.

As the processing circuit 100 may perform the image division and blocks/patches-to-score conversion operations 300 on the aforementioned any image (e.g., the image A or the target image) to just generate the one or more sets of block/patch scores {{IMG_BLK_SCOREₖ₀(i, j)|i=1 . . . I, j=1 . . . J}, {IMG_BLK_SCOREₖ₁(i, j)|i=1 . . . I, j=1 . . . J}, . . . } as the associated artifact scores {{IMG_BLK_SCOREₖ₀(i, j)|i=1 . . . I, j=1 . . . J}, {IMG_BLK_SCOREₖ₁(i, j)|i =1 . . . I, j=1 . . . J}, . . . } of the one or more preliminarily chosen artifacts #k0, #k1, etc., having no need to generate any set of block/patch scores {IMG_BLK_SCOREₖ(i, j)|i=1 . . . I, j=1 . . . J} of any non-chosen artifact #k (e.g., any predetermined type of artifacts #k that differs from the preliminarily chosen artifacts #k0, #k1, etc. among the multiple predetermined types of artifacts #1, #2 . . . and #n), the processing circuit 100 may skip the associated calculation operations regarding the aforementioned any non-chosen artifact #k, having no need to calculate the summation Σ_{i=1 . . . I, j=1 . . . J} (IMG_BLK_SCOREₖ(i, j)) of the non-chosen artifact #k (e.g., the summation Σ_{i=1 . . . I, j=1 . . . J} (IMG1_BLK_SCOREₖ(i, j)) of the non-chosen artifact #k or the summation Σ_{i=1 . . . I, j=1 . . . J} (IMG0_BLK_SCOREₖ(i, j)) of the non-chosen artifact #k) and accumulate the summation Σ_{i=1 . . . I, j=1 . . . J} (IMG_BLK_SCOREₖ(i, j)) of the non-chosen artifact #k into the final image score IMG_FINAL_SCORE of the aforementioned any image, such as the final image score IMG1_FINAL_SCORE of the image A or the final image score IMG0_FINAL_SCORE of the target image. For better comprehension, the aforementioned any set of block/patch scores {IMG_BLK_SCOREₖ(i, j)|i=1 . . . I, j=1 . . . J} of the aforementioned any non-chosen artifact #k may be regarded as zero, and the summation Σ_{i=1 . . . I, j=1 . . . J} (IMG_BLK_SCOREₖ(i, j)) corresponding to the aforementioned any non-chosen artifact #k in the equation for calculating the final image score IMG_FINAL_SCORE (e.g., the final image score IMG1_FINAL_SCORE or the final image score IMG0_FINAL_SCORE), such as that in the k^{th} product (Wₖ*(Σ_{i=1 . . . I, j=1 . . . J} (IMG_BLK_SCOREₖ(i, j)))) (e.g., the k^{th} product (Wₖ*(Σ_{i=1 . . . I, j=1 . . . J} (IMG1_BLK_SCOREₖ(i, j)))) or the k^{th} product (Wₖ*(Σ_{i=1 . . . I, j=1 . . . J} (IMG0_BLK_SCOREₖ(i, j))))) within the equation for calculating the final image score IMG_FINAL_SCORE, may also be regarded as zero, but the present invention is not limited thereto. For brevity, similar descriptions for this embodiment are not repeated in detail here.

According to some embodiments, the processing circuit 100 may temporarily replace the remaining portion of weights {Wₖ} among the respective weights {W₁, W₂, . . . , Wₙ} of the multiple predetermined types of artifacts #1, #2 . . . and #n with zero, and more particularly, temporarily set the weight Wₖ of each non-chosen artifact #k (e.g., any predetermined type of artifacts #k that differs from the preliminarily chosen artifacts #k0, #k1, etc.) among the multiple predetermined types of artifacts #1, #2 . . . and #n to be equal to zero. For brevity, similar descriptions for these embodiments are not repeated in detail here.

According to some embodiments, the parameters #A1, #A2, #A3, etc. of the series of image process/processing modules #1, #2, #3, etc. within the image signal processing pipeline 110 may be stored in multiple registers (e.g., control registers) of the processing circuit 100, but the present invention is not limited thereto. For example, the multiple registers may be positioned outside the image signal processing pipeline 110. In another example, the multiple registers may be integrated into the image signal processing pipeline 110. In some examples, a set of first registers among the multiple registers may be positioned outside the image signal processing pipeline 110, and a set of second registers among the multiple registers may be integrated into the image signal processing pipeline 110. In addition, the processing circuit 100 may adjust the parameters #A1, #A2, #A3, etc. in the multiple registers when there is a need. During performing the auto-tuning of the image signal processing pipeline 110, the processing circuit 100 may adjust any parameter among the parameters #A1, #A2, #A3, etc. in the multiple registers. For brevity, similar descriptions for these embodiments are not repeated in detail here.

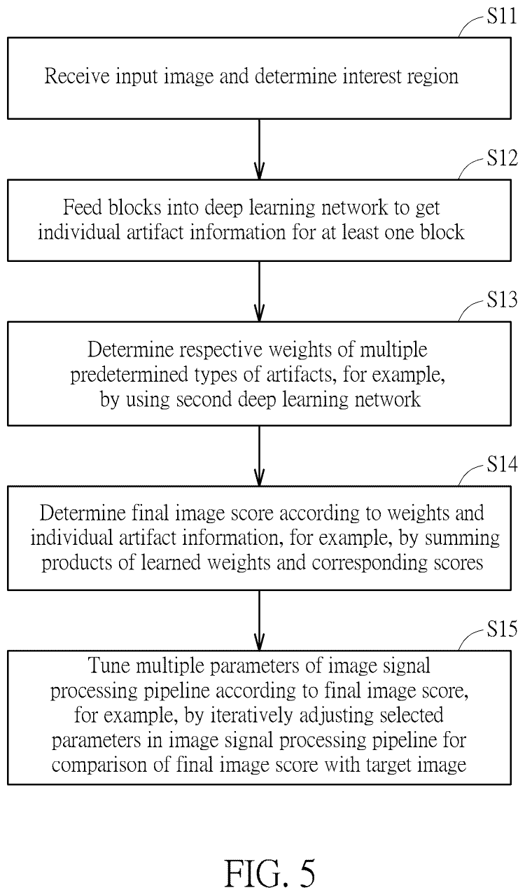

FIG. 5 is a flowchart of the method according to an embodiment of the present invention. The method can be applied to the processing circuit 100 and the image signal processing pipeline 110 therein, as well as the electronic device equipped with the processing circuit 100. For example, the processing circuit 100 may capture one image, select one or more parameters pertinent to the image quality, strategically segment the image into multiple 90×90 (or “90 by 90”) pixels blocks (e.g., the blocks having a common size of (90*90) pixels) for further analysis, feed the blocks into the aforementioned at least one deep learning network to acquire individual scores for each block, cumulatively sum these individual scores to ultimately produce a comprehensive score for the entire image in or regarding each artifact #k, and employ the deep learning method regarding the weights {W₁, W₂, . . . , Wₙ} based on the individual artifact scores to determine the weighted importance of each artifact #k, such as the weighted importance for being subsequently utilized to compute a holistic final score for the complete image, and more particularly, may sum the products of the learned weights {W₁, W₂, . . . , Wₙ} and their corresponding scores such as the summations {Σ_{i=1 . . . I, j=1 . . . J} (IMG1_BLK_SCORE₁(i, j)), Σ_{i=1 . . . I, j=1 . . . J} (IMG1_BLK_SCORE₂(i, j)), . . . , Σ_{i=1 . . . I, j=1 . . . J} (IMG1_BLK_SCOREₙ(i, j))} to obtain the final image score IMG1_FINAL_SCORE, and perform the auto-tuning on the selected parameter (e.g., a portion or all of the parameters #A1, #A2, #A3, etc.) according to the final image score IMG1_FINAL_SCORE, in order to get better quality of image, but the present invention is not limited thereto. In some examples, one or more operations among the above operations may vary.

In Step S11, the processing circuit 100 may receive an input image (e.g., the original image whose subset is equal to the image A or the source image) with the image signal processing pipeline 110 to generate a processed image (e.g., the image A or the source image) corresponding to the input image, and determine the interest region (e.g., the interest region 301) of the processed image according to at least one setting, where the interest region of the processed image comprises multiple blocks. For example, the multiple blocks may represent the first blocks/patches {IMG1_BLK(i, j)|i=1 . . . I, j=1 . . . J} obtained from dividing the image A, such as the first blocks/patches {IMG1_BLK(i, j)|i=1 . . . I, j=1 . . . J} within the first blocks/patches set 211 shown in FIG. 2 or the first blocks/patches {IMG1_BLK(i, j)|i=1 . . . I, j=1 . . . J} within the first blocks/patches set 311 shown in FIG. 3. In addition, the aforementioned at least one setting may comprise a default setting and a user setting, and the interest region (e.g., the interest region 301) may be determined according to any setting among the default setting and the user setting.

In Step S12, the processing circuit 100 may feed the multiple blocks such as the first blocks/patches {IMG1_BLK(i, j)|i=1 . . . I, j=1 . . . J} into the aforementioned at least one deep learning network (e.g., the DL network 120) of the aforementioned at least one deep learning model to get individual artifact information for at least one block among the multiple blocks, such as at least one block IMG1_BLK(i, j) among the first blocks/patches {IMG1_BLK(i, j)|i=1 . . . I, j=1 . . . J}. More particularly, the individual artifact information may comprise a set of individual artifact scores {IMG1_BLK_SCOREₖ(i, j)} for the aforementioned at least one block among the multiple blocks, such as the set of individual artifact scores {IMG1_BLK_SCOREₖ(i, j)|k=1, 2 . . . n} respectively corresponding to the multiple predetermined types of artifacts #1, #2 . . . and #n. In addition, the processing circuit 100 may feed the multiple blocks such as the first blocks/patches {IMG1_BLK(i, j)|i=1 . . . I, j=1 . . . J} into the aforementioned at least one deep learning network such as the DL network 120, in order to get multiple sets of individual artifact scores {{{IMG1_BLK_SCOREₖ(i=1, j=1)|k=1, 2 . . . n}, . . . , {IMG1_BLK_SCOREₖ(i=1, j=J)|k=1, 2 . . . n}}, . . . , {{IMG1_BLK_SCOREₖ(i=I, j=1)|k=1, 2 . . . n}, . . . , {IMG1_BLK_SCOREₖ(i=I, j=J)|k=1, 2 . . . n}}} for the multiple blocks such as the first blocks/patches {IMG1_BLK(i, j)|i=1 . . . I, j=1 . . . J}, respectively, for determining a comprehensive score such as the summation Σ_{i=1 . . . I, j=1 . . . J} (IMG1_BLK_SCOREₖ(i, j)) for the entire processed image, i.e., the whole of the processed image such as the image A (or the source image), regarding more than one type of artifacts #k among the multiple predetermined types of artifacts #1, #2 . . . and #n.

In Step S13, the processing circuit 100 may determine the respective weights {W₁, W₂, . . . , Wₙ} of the multiple predetermined types of artifacts #1, #2 . . . and #n, for example, by using the second deep learning network (e.g., the DL network 130) of the other deep learning model. Based on the individual artifact information such as the set of individual artifact scores {IMG1_BLK_SCOREₖ(i, j)} for the aforementioned at least one block among the multiple blocks, in particular, the multiple sets of individual artifact scores {{{IMG1_BLK_SCOREₖ(i=1, j=1)|k=1, 2 . . . n}, . . . , {IMG1_BLK_SCOREₖ(i=1, j=J)|k=1, 2 . . . n}}, . . . , {{IMG1_BLK_SCOREₖ(i=I, j=1)|k=1, 2 . . . n}, . . . , {IMG1_BLK_SCOREₖ(i=I, j=J)|k=1, 2 . . . n}}} for the multiple blocks such as the first blocks/patches {IMG1_BLK(i, j)|i=1 . . . I, j=1 . . . J}, the processing circuit 100 may determine the respective weights {W₁, W₂, . . . , Wₙ} of the multiple predetermined types of artifacts #1, #2 . . . and #n by using the second deep learning network such as the DL network 130.

In Step S14, the processing circuit 100 may determine the final image score IMG1_FINAL_SCORE of the processed image (e.g., the image A or the source image) according to the weights {W₁, W₂, . . . , Wₙ} and the individual artifact information, for example, by summing the products {(Wₖ*(Σ_{i=1 . . . I, j=1 . . . J} (IMG1_BLK_SCOREₖ(i, j))))|k=1 . . . n} of the learned weights {W₁, W₂, . . . , Wₙ} and the corresponding scores such as the summations {Σ_{i=1 . . . I, j=1 . . . J} (IMG1_BLK_SCORE₁(i, j)), Σ_{i=1 . . . I, j=1 . . . J} (IMG1_BLK_SCORE₂(i, j)), . . . , Σ_{i=1 . . . I, j=1 . . . J} (IMG1_BLK_SCOREₙ(i, j))}. More particularly, the processing circuit 100 may cumulatively sum the individual scores {IMG1_BLK_SCOREₖ(i, j))} regarding the aforementioned more than one type of artifacts #k among the multiple sets of individual artifact scores #1, #2 . . . and #n to generate the comprehensive score such as the summation Σ_{i=1 . . . I, j=1 . . . J} (IMG1_BLK_SCOREₖ(i, j)) regarding the aforementioned more than one type of artifacts #k, calculate the product (Wₖ*(Σ_{i=1 . . . I, j=1 . . . J} (IMG1_BLK_SCOREₖ(i, j)))) of the weight Wₖ regarding the aforementioned more than one type of artifacts #k among the weights {W₁, W₂, . . . , Wₙ} and the comprehensive score such as the summation Σ_{i=1 . . . I, j=1 . . . J} (IMG1_BLK_SCOREₖ(i, j)) regarding the aforementioned more than one type of artifacts #k, and sum multiple products such as the n products {(Wₖ*(Σ_{i=1 . . . I, j=1 . . . J} (IMG1_BLK_SCOREₖ(i, j))))|k=1 . . . n} respectively corresponding to the multiple predetermined types of artifacts #1, #2 . . . and #n to generate the final image score IMG1_FINAL_SCORE.

In Step S15, the processing circuit 100 may tune multiple parameters of the image signal processing pipeline 110, such as at least one portion (e.g., a portion or all) of the parameters #A1, #A2, #A3, etc. of the series of image process/processing modules #1, #2, #3, etc. within the image signal processing pipeline 110, according to the final image score IMG1_FINAL_SCORE, for example, by iteratively adjusting the selected parameters (e.g., a portion or all of the parameters #A1, #A2, #A3, etc.) in the image signal processing pipeline 110 for comparison of the final image score IMG1_FINAL_SCORE with the target image (or the final image score IMG0_FINAL_SCORE thereof). More particularly, the final image score IMG0_FINAL_SCORE of the target image may be regarded as the target image score IMG0_FINAL_SCORE, and the processing circuit 100 may compare the final image score IMG1_FINAL_SCORE with the target image score IMG0_FINAL_SCORE of the target image to generate a comparison result such as the difference DIFF between the final image score IMG1_FINAL_SCORE and the target image score IMG0_FINAL_SCORE, and adjust the multiple parameters (e.g., a portion or all of the parameters #A1, #A2, #A3, etc.) according to the comparison result such as the difference DIFF, where DIFF=(IMG1_FINAL_SCORE−IMG0_FINAL_SCORE). For brevity, similar descriptions for this embodiment are not repeated in detail here.

For better comprehension, the method may be illustrated with the working flow shown in FIG. 5, but the present invention is not limited thereto. According to some embodiments, one or more steps may be added, deleted, or changed in the working flow shown in FIG. 5. For example, any operation among the operations of Steps S12 and S13 (e.g., the operation of feeding the multiple blocks into the deep learning network to get the individual artifact information for the aforementioned at least one block among the multiple blocks and the operation of determining the respective weights {W₁, W₂, . . . , Wₙ} of the multiple predetermined types of artifacts #1, #2 . . . and #n) may be performed multiple times (e.g., M times), for determining multiple final image scores {IMG1_FINAL_SCORE} (e.g., M final image scores {IMG1_FINAL_SCORE(m)|m=1 . . . M}) respectively corresponding to the multiple times (e.g., M times) in Step S14, respectively. In addition, the processing circuit 100 may automatically tune the multiple parameters such as a portion or all of the parameters #A1, #A2, #A3, etc. to achieve the minimum MIN({DIFF(m)=(IMG1_FINAL_SCORE(m)−IMG0_FINAL_SCORE)|m=1 . . . M}) of multiple differences {DIFF(m)=(IMG1_FINAL_SCORE(m)−IMG0_FINAL_SCORE)|m=1 . . . M} between the multiple final image scores {IMG1_FINAL_SCORE(m)|m=1 . . . M } and the target image score IMG0_FINAL_SCORE of the target image, where “MIN( )” may represent a minimum function for calculating the minimum of multiple input values thereof such as the multiple differences {DIFF(m)=(IMG1_FINAL_SCORE(m)−IMG0_FINAL_SCORE)|m=1 . . . M}. This is for illustrative purposes only, and is not meant to be a limitation of the present invention. According to another embodiment, the processing circuit 100 may automatically tune the multiple parameters such as a portion or all of the parameters #A1, #A2, #A3, etc. to make all of the multiple differences {DIFF(m)=(IMG1_FINAL_SCORE(m)−IMG0_FINAL_SCORE)|m=1 . . . M} between the multiple final image scores {IMG1_FINAL_SCORE(m)|m=1 . . . M } and the target image score IMG0_FINAL_SCORE of the target image be less than a certain threshold such as a predetermined threshold, in order to achieve a better tuning result. For brevity, similar descriptions for these embodiments are not repeated in detail here.

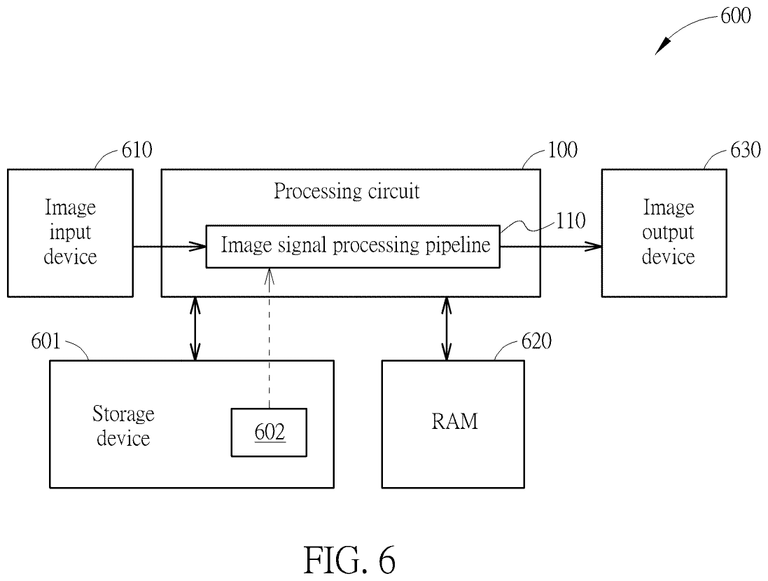

FIG. 6 is a diagram illustrating an electronic device 600 involved with the method according to an embodiment of the present invention. Examples of the electronic device 600 may include, but are not limited to: a personal computer (PC) such as a desktop computer and a laptop computer, a server, an all in one (AIO) computer, a tablet computer and a multifunctional mobile phone as well as a wearable device. As shown in FIG. 6, the electronic device 600 may comprise the processing circuit 100 equipped with the image signal processing pipeline 110, and may further comprise a computer-readable medium such as a storage device 601, an image input device 610, a random access memory (RAM) 620 and an image output device 630. In addition, the processing circuit 100 may be arranged to control operations of the electronic device 600.

Regarding a program-based pipeline control scheme of the method, the image signal processing pipeline 110 may be implemented by way of at least one program running on the processing circuit 100. More particularly, the computer-readable medium such as the storage device 601 may be arranged to store a program code 602, for being loaded onto the processing circuit 100 to act as the image signal processing pipeline 110 running on the processing circuit 100. When executed by the processing circuit 100, the program code 602 may cause the processing circuit 100 to operate according to the method, in order to perform the associated operations in the partial-image-based control scheme, such as the operations of the image signal processing pipeline 110, the DL networks 120 and 130, the arithmetic circuit 140, etc. For example, multiple program modules may run on the processing circuit 100 for controlling the operations of the electronic device 600, where the image signal processing pipeline 110 may be one of the multiple program modules, but the present invention is not limited thereto. In addition, the image input device 610 may be arranged to input or receive multiple input images, the RAM 620 may be arranged to temporarily store the multiple input images, the image signal processing pipeline 110 running on the processing circuit 100 may be arranged to process the multiple input images, and more particularly, perform image signal processing on the multiple input images to generate multiple processed images as multiple output images, and the image output device 630 may be arranged to output or display the multiple output images, but the present invention is not limited thereto. For example, the RAM 620 may be arranged to temporarily store the multiple input images and the multiple output images, and/or the storage device 601 may be arranged to store the multiple input images and the multiple output images.

In the above embodiment, the storage device 601 can be implemented by way of a hard disk drive (HDD), a solid state drive (SSD) and a non-volatile memory such as a Flash memory, the image input device 610 can be implemented by way of a camera, the processing circuit 100 can be implemented by way of at least one processor such as at least one central processing unit (CPU), at least one graphics processing unit (GPU), etc., the RAM 620 can be implemented by way of a dynamic random access memory (DRAM), and the image output device 630 can be implemented by way of a display device such as a liquid-crystal display (LCD) panel, an organic light-emitting diode (OLED) panel, etc., where the display device can be implemented as a touch-sensitive panel, but the present invention is not limited thereto. According to some embodiments, the architecture of the electronic device 600 and/or the components therein may vary.

According to some embodiments, regarding a hardware-based pipeline control scheme of the method, the image signal processing pipeline 110 may be implemented by way of at least one sub-circuit among multiple sub-circuits of the processing circuit 100. More particularly, the image signal processing pipeline 110 may comprise the aforementioned at least one processor, and the architecture shown in FIG. 2 may be implemented by way of an application-specific instruction-set processor (ASIP) among the aforementioned at least one processor. For brevity, similar descriptions for these embodiments are not repeated in detail here.

According to some embodiments, the sizes of the (I*J) first blocks/patches {IMG1_BLK(i, j)|i=1 . . . I, j=1 . . . J} and/or the (I*J) first blocks/patches {IMG1_BLK(i, j)|i=1 . . . I, j=1 . . . J} may vary, where the DL network 120 may generate and output the block/patch scores {{IMG1_BLK_SCORE₁(i, j)|i=1 . . . I, j=1 . . . J}, {IMG1_BLK_SCORE₂(i, j)|i=1 . . . I, j=1 . . . J}, . . . , {IMG1_BLK_SCOREₙ(i, j)|i=1 . . . I, j=1 . . . J}} of the first blocks/patches {IMG1_BLK(i, j)|i=1 . . . I, j=1 . . . J} and generate and output the block/patch scores {{IMG0_BLK_SCORE₁(i, j)|i=1 . . . I, j=1 . . . J}, {IMG0_BLK_SCORE₂(i, j)|i=1 . . . I, j=1 . . . J}, . . . , {IMG0_BLK_SCOREₙ(i, j)|i=1 . . . I, j=1 . . . J}} of the target blocks/patches {IMG0_BLK(i, j)|i=1 . . . I, j=1 . . . J} as mentioned above while ignoring any decrement/increment of the sizes, without being hindered by the variation of the sizes. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing auto-tuning with aid of deep learning, the method being applied to a processing circuit within an electronic device, the method comprising:
receiving an input image with an image signal processing pipeline to generate a processed image corresponding to the input image and determining an interest region of the processed image, wherein the interest region of the processed image comprises multiple blocks;
feeding the multiple blocks into a deep learning network to get individual artifact information for at least one block among the multiple blocks;
determining respective weights of multiple predetermined types of artifacts;
determining a final image score of the processed image according to the weights and the individual artifact information; and
tuning multiple parameters of the image signal processing pipeline according to the final image score.

2. The method of claim 1, wherein the interest region is determined according to any setting among a default setting and a user setting.

3. The method of claim 1, wherein the individual artifact information comprises a set of individual artifact scores for said at least one block among the multiple blocks, the set of individual artifact scores respectively corresponding to the multiple predetermined types of artifacts.

4. The method of claim 1, wherein the deep learning network represents a first deep learning network of at least one deep learning model; and determining the respective weights of the multiple predetermined types of artifacts comprises:
based on the individual artifact information, determining the respective weights of the multiple predetermined types of artifacts by using a second deep learning network of another deep learning model.

5. The method of claim 1, wherein the individual artifact information comprises a set of individual artifact scores for said at least one block among the multiple blocks; and
feeding the multiple blocks into the deep learning network to get the individual artifact information for said at least one block among the multiple blocks comprises:
feeding the multiple blocks into the deep learning network to get multiple sets of individual artifact scores for the multiple blocks, respectively, for determining a comprehensive score for the entire processed image regarding more than one type of artifacts among the multiple predetermined types of artifacts.

6. The method of claim 5, wherein determining the final image score according to the weights and the individual artifact information comprises:
cumulatively summing individual scores regarding the more than one type of artifacts among the multiple sets of individual artifact scores to generate the comprehensive score regarding the more than one type of artifacts;
calculating a product of a weight regarding the more than one type of artifacts among the weights and the comprehensive score regarding the more than one type of artifacts; and
summing multiple products respectively corresponding to the multiple predetermined types of artifacts to generate the final image score.

7. The method of claim 1, wherein tuning the multiple parameters of the image signal processing pipeline according to the final image score comprises:
comparing the final image score with a target image score of a target image to generate a comparison result; and
adjusting the multiple parameters according to the comparison result.

8. The method of claim 1, wherein any operation among an operation of feeding the multiple blocks into the deep learning network to get the individual artifact information for said at least one block among the multiple blocks and an operation of determining the respective weights of the multiple predetermined types of artifacts is performed multiple times, for determining multiple final image scores respectively corresponding to the multiple times;
and tuning the multiple parameters of the image signal processing pipeline according to the final image score further comprises:
automatically tuning the multiple parameters to achieve a minimum of differences between the multiple final image scores and a target image score of a target image.

9. An apparatus that operates according to the method of claim 1, wherein the apparatus comprises at least the processing circuit within the electronic device.

10. The apparatus of claim 9, wherein the processing circuit comprises:
the deep learning network, coupled to the image signal processing pipeline, arranged to receive the multiple blocks to generate the individual artifact information.

11. The apparatus of claim 10, wherein the deep learning network represents a first deep learning network of at least one deep learning model; and the processing circuit further comprises:
a second deep learning network of another deep learning model, the second deep learning network coupled to the image signal processing pipeline, wherein based on the individual artifact information, the second deep learning network is arranged to determine the respective weights of the multiple predetermined types of artifacts.
